(19) United States
(12) Patent Application Publication
(10) Pub. No.: US 2022/0231359 A1
(43) Pub. Date: Jul. 21, 2022

(54) BATTERY CASE

(71) Applicant: SAFRAN ELECTRONICS & DEFENSE COCKPIT SOLUTIONS, Montreuil (FR)

(72) Inventor: Julien Giron, Montreuil (FR)

(73) Assignee: SAFRAN ELECTRONICS & DEFENSE COCKPIT SOLUTIONS, Montreuil (FR)

(21) Appl. No.: 17/607,110

(22) PCT Filed: May 6, 2020
(86) PCT No.: PCT/EP2020/062600

§ 371 Date: Oct. 28, 2021

(30) Foreign Application Priority Data
May 6, 2019 (FR) FR 1904729

(51) Int. Cl. H01M 50/128; H01M 10/658; H01M 10/613; H01M 10/6556; H01M 50/119; H01M 50/143; H01M 50/14; H01M 50/30; B32B 5/24; B32B 5/02; B32B 9/00; B32B 15/20; B32B 15/14; B32B 9/04

(52) U.S. Cl. CPC H01M 50/128; B32B 2307/3065; H01M 10/613; H01M 10/6556; H01M 50/119; H01M 50/143; H01M 50/14; H01M 50/30; B32B 5/245; B32B 5/024; B32B 9/005; B32B 15/20; B32B 15/14; B32B 9/047; B32B 9/046; B32B 2262/101; B32B 2262/105; B32B 2307/304; H01M 10/658

(57) ABSTRACT

A battery case, comprising an outer housing for mechanical protection and an inner casing for thermal confinement, said inner casing including at least one thermal insulation component and at least one flame protection component.

The present invention relates, in general, to the protection of batteries.

In particular, the invention relates to a battery case and, more precisely, to a case for thermal and mechanical protection of a battery.

Certain types of batteries such as lithium-ion batteries are particularly subject to thermal runaway. Indeed, the electrolyte that they contain, in the form of lithium salts, is highly flammable. Consequently, an overheating of the battery can lead to it catching fire, accompanied by the release of toxic gases, which can lead to it exploding.

In the case of onboard batteries, for example disposed in an airplane, their proximity to the fuel zone makes any heating of the battery considerably risky. The increase in the temperature of the walls of the battery is therefore unacceptable and it is necessary to provide means for its thermal insulation.

Solutions aiming to contain the melted debris projected during the explosion are known. These solutions involve disposing a covering tarp or an anti-deflagration bag around the battery.

However, the tarp and the bag do not seal the battery and they also do not allow to ensure thermal confinement.

Moreover, they do not provide any mechanical protection. However, batteries further require protection against mechanical stresses so as to be able to preserve their integrity.

It is also known to use a housing made of stainless steel or made of titanium, disposed around the battery, and protecting it both mechanically and thermally.

However, although highly resistant, the mass of such a housing is too significant for its use to be possible in the field of aviation, the innovations of which are aimed on the contrary at making the onboard devices lighter.

For the reasons mentioned above, the invention relates to a light battery case, allowing both protection against the outside mechanical stresses and the formation of a thermal barrier capable of containing the exothermal reaction, the projections and the flames in the housing of thermal runaway of the battery.

A battery case is therefore proposed, comprising an outer housing for mechanical protection and an inner casing for thermal confinement, said inner casing including at least one thermal insulation component and at least one flame protection component.

According to one embodiment, said inner casing is a multilayer structure.

According to one feature, the inner casing can comprise at least one layer including a thermal insulation component and a flame protection component.

Advantageously, the inner casing can comprise an outer layer disposed facing the outer housing and including a component impermeable to water.

Even more advantageously, the inner casing can comprise an inner layer disposed facing the battery and including a component impermeable to water.

Preferably, a thermal insulation component in the form of foam is disposed between said outer and inner layers of the inner casing for thermal confinement.

According to one feature, all of the layers of the inner casing for thermal confinement can comprise a thermal insulation component.

Advantageously the thermal insulation component can include a material chosen from glass fibres, silica fibres or a mixture thereof.

According to one embodiment, the flame protection component comprises vermiculite.

Moreover, the inner casing can be a structure at least partly woven.

The outer housing can comprise aluminium.

Preferably, the outer housing and/or the inner casing for thermal confinement comprise a vent.

According to one embodiment means for cooling the battery can be arranged in the case.

According to one feature, the inner casing for confinement can include a network for cooling the battery comprising one or more channels for guiding the air and a plurality of orifices for output of air from the channels towards the battery.

### BRIEF DESCRIPTION OF FIGURES

Other goals, advantages and features will become apparent from the following description, given for purely illustrative purposes and made in reference to the appended drawings in which:

FIG. 1 is a perspective view of a battery case according to the invention, including an outer housing and an inner casing;

FIG. 2 is a transverse cross-sectional view illustrating a first embodiment of an inner casing of a battery case according to the invention; and

FIG. 3 is a transverse cross-sectional view of an inner casing of a case according to the invention, according to a second embodiment.

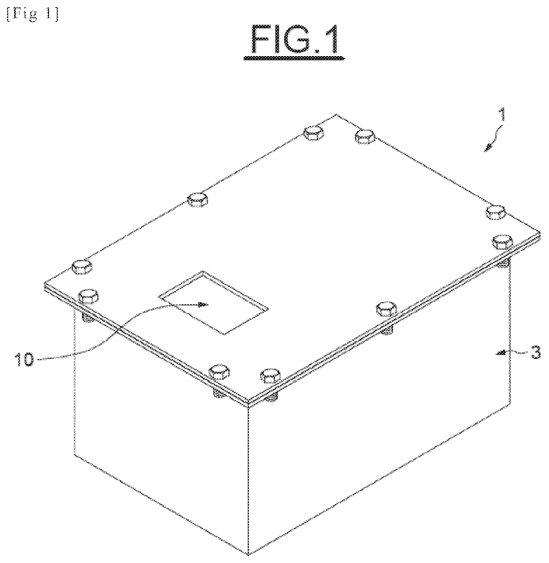

FIGS. 1 to 3 illustrate a case 1 for a battery 2, for example a lithium-ion battery.

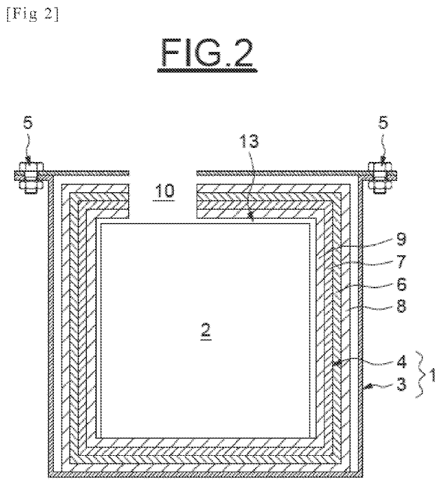

As visible in the cross-sectional view of FIG. 2, the case 1 comprises an outer housing 3 as well as an inner casing 4, disposed around the battery 2. The inner casing 4 is advantageously configured to be disposed between the outer housing 3 and the battery 2.

On the one hand, the outer housing 3 provides the battery 2 with mechanical protection and, on the other hand, the inner casing 4 provides insulation and thermal protection by thermally confining the battery 2.

In the example illustrated, the outer housing 3 forms a sealed structure and it is independent of the inner casing 4.

For a use of the case 1 in the field of aviation, the material chosen for the outer housing 3 is, preferably, a material lighter than steel and stainless steel, for example aluminium, or a composite material.

The outer housing 3 can be formed by a plurality of plates that can be assembled, for example, by welding or screwing. In the example illustrated, the outer housing 3 includes a cover fastened to the rest of the housing by screws 5, facilitating the access to the battery 2.

The inner casing 4 includes at least one thermal insulation component. According to one example, glass fibres or silica fibres that have a high resistance to high temperatures, ranging up to 1200° C., or a mixture thereof can be chosen.

It further comprises at least one flame protection component, for example vermiculite, in order to confine the battery 2 and contain the possible projections and flames in the case of overheating and explosion.

Moreover, the inner casing 4 can be a multilayer structure, preferably flexible, in which each layer can thus include specific properties.

The various layers of the inner casing 4 can be formed by plates or one or more woven materials.

In the embodiment illustrated in the drawings, the inner casing 4 comprises an anti-flame layer 6 including glass fibres and vermiculite, as well as a layer of thermal insulation 7 of the battery 2, in the form of foam, also including glass fibres. This foam is an effective thermal insulator, allowing to trap air, and thus to reduce the transfer of heat through the fabric to limit the rise in temperature of the structure.

Advantageously, the inner casing 4 can also comprise an outer layer 8 disposed facing the outer housing 3 and/or an inner layer 9 disposed facing the battery, including a component impermeable to water, for example silicone. The outer 8 and inner 9 layers thus allow to seal the inner casing 4 and prevent the passage of water towards the battery 2.

The anti-flame layer 6 and the layer of long-term thermal insulation 7 are disposed between the outer 8 and inner 9 layers.

Advantageously, each layer of the multilayer structure of the example illustrated comprises a thermal insulation component, here glass fibres which also have the advantage of being an electric insulator.

Moreover, as shown in the drawings, the case 1 can comprise a vent 10 letting the gases release during the thermal runaway of the battery 2 escape.

Preferably, the outer housing 3 and the inner casing 4 both comprise a vent 10, on the upper face of the case 1.

Preferably, the case 1 also comprises means for cooling the battery 2 in order to limit overheating and prevent thermal runaway.

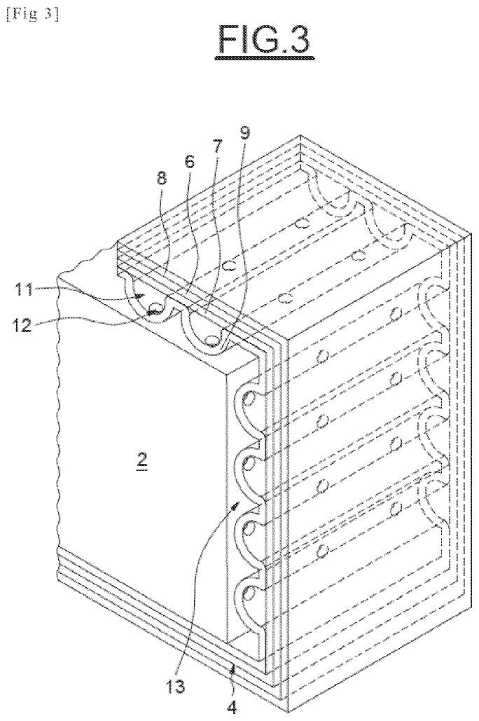

According to a second embodiment illustrated in FIG. 3, the inner casing 4 can include cooling means. For a better understanding of the configuration of the inner casing 4, the outer housing 3 is not shown.

The inner casing 4 can include a network for cooling the battery 2 comprising several channels 11 for guiding the air and a plurality of orifices 12 for output of air from said channels 11 towards the battery 2.

In the example illustrated, the channels 11 of the cooling network are arranged between the outer layer 9 and the layer of long-term thermal insulation 7, via a surplus of material in the inner layer 9.

Advantageously, the case 1 is configured so that a space 13 remains between the battery 2 and the inner casing 4 allowing in particular the circulation of air for the cooling of the battery 2.

Air can thus be blown, for example from the vent 10, into the channels 11 for guiding air so that the air is delivered into the space 13 via the air-output orifices 12 in order to cool the battery 2.

There can of course be in the case 1 interfaces for electric connection of the battery 2.

Moreover, the battery 2 illustrated is a lithium-ion battery for which the case 1 according to the invention is particularly advantageous given the risk of thermal runaway in this type of battery.

However, it is of course possible for the case as described above to be used for a piece of electric equipment of a type other than a battery.

The case 1 as described above allows to separate the mechanical protection means and the thermal protection means of the battery 2. The case 1 can thus be made lighter.

1. A battery case, comprising: an outer housing for mechanical protection and an inner casing for thermal confinement, said inner casing including at least one thermal insulation component and at least one flame protection component, and the outer housing being independent of the inner casing.

2. The case according to claim 1, wherein said inner casing is a multilayer structure.

3. The case according to claim 2, wherein said inner casing comprises at least one layer including a thermal insulation component and a flame protection component.

4. The case according to claim 2, wherein said inner casing comprises an outer layer disposed facing the outer housing and including a component impermeable to water.

5. The case according to claim 2, wherein said inner casing comprises an inner layer disposed facing a battery and including a component impermeable to water.

6. The case according to claim 5, wherein a thermal insulation component in the form of foam is disposed between said inner layer and an outer layer of the inner casing for thermal confinement.

7. The case according to claim 2, wherein all of the layers of said inner casing comprise a thermal insulation component.

8. The case according to claim 1, wherein the thermal insulation component includes a material chosen from glass fibers, silica fibers, or a mixture thereof.

9. The case according to claim 1, wherein the flame protection component comprises vermiculite.

10. The case according to claim 1, wherein said inner casing is a structure at least partly woven.

11. The case according to claim 1, wherein the outer housing comprises aluminum.

12. The case according to claim 1, wherein the outer housing and/or the inner casing comprises a vent.

13. The case according to claim 1, further comprising means for cooling a battery.

14. The case according to claim 13, wherein the inner casing includes a network for cooling the battery comprising one or more channels for guiding the air and a plurality of orifices for output of air from the channels towards the battery.

15. The case according to claim 4, wherein a thermal insulation component in the form of foam is disposed between said outer layer and an inner layer of the inner casing for thermal confinement.
